(19) United States
(12) Patent Application Publication
(10) Pub. No.: US 2016/0295028 A1
(43) Pub. Date: Oct. 6, 2016

(54) TRACKING USAGE WINDOW FOR QUOTA CONTROL POLICY

(71) Applicant: ALCATEL-LUCENT CANADA INC., Ottawa (CA)

(72) Inventors: Xu Chen, Ottawa (CA); Zhaoliang Ding, Ottawa (CA); Hua Song, Kanata (CA); Michael Tofinetti, Kanata (CA); Min Chen, Ottawa (CA); Zhihao Wang, Ottawa (CA); John K. Davis, Gatineau (CA); Liying Liu, Kanata (CA); Richard A. Brunet, Ottawa (CA)

(21) Appl. No.: 14/675,066

(22) Filed: Mar. 31, 2015

(51) Int. Cl. H04M 15/00

(52) U.S. Cl. CPC H04M 15/8214; H04M 15/61; H04M 15/887; H04M 15/66

(57) ABSTRACT

A method, apparatus, and machine readable storage medium is disclosed for tracking a usage window for a Quota Control Policy for controlling a subscriber account on a network node for a current time period based short-term usage characteristics namely on data traffic usage during a sliding window of preceding time periods.

### CROSS REFERENCE TO RELATED APPLICATIONS

The present application is related to co-pending United States Patent Application entitled “Quota Control Policy” (Chen et al.), filed concurrently herewith, the entire content of which is incorporated herein by reference.

### FIELD OF INVENTION

The invention is directed to communications systems and more specifically, monitoring and controlling data usage.

### BACKGROUND

With the rapid growth of wireless and wireline broadband communications, service providers are increasingly looking for innovative and personalized subscriber services. Subscribers typically have a quota for data usage over a defined billing period. Data is normally consumed gradually over the course of the billing period. However, it is possible for the subscriber to use a month's worth of data within a few days or to consume a majority of their data on weekends. Typical solutions include, when the quota has been exceeded: capping data usage or suspending service; to add additional billing for the excess data usage, which could result in large, unexpected bills, (“bill shock”); or to limit the subscriber to a lower bandwidth to minimize further data usage in excess of the quota.

It would be highly desirable to help influence or control a subscriber's data usage to smooth the consumption curve of data usage throughout the billing period to help avoid terminating subscriber services or introducing “bill shock” to subscribers for data usage exceeding their quota, while maintaining services throughout the billing period.

### SUMMARY

Illustrative embodiments provide a policy, herein referred to as a Quota Control Policy (QCP) that can monitor and control the data usage in an account based on short-term usage characteristics, by specifying a maximum amount of usage to be consumed during a sliding window of time within a billing period which would trigger an action. This policy can be independent of a standard metering limit so that both a Quota Control Policy and a Metering Limit can be in effect simultaneously.

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments are described, including a method A method for tracking data usage in a sliding window of previous periods for a subscriber account, the method performed by a processor on a network node. The method comprises the steps of: during a current period, periodically receiving usage data for a subscriber account and adding the received usage data to a current period accumulator; when the current period expires: copying the value in the current period accumulator to previous period usage memory; calculating a total data usage for the sliding window of previous periods; and determining if the total data usage for the sliding window of previous periods exceeds a rolling window usage threshold and if so, setting a window-usage-exceeded state for the subscriber account.

Various exemplary embodiments are described wherein the calculating a total data usage comprises adding data usage values corresponding to each of the previous periods within the sliding window of previous periods.

Various exemplary embodiments are described wherein the calculating a total data usage comprises adding data usage values corresponding to each of the previous periods within the sliding window of previous periods.

Various exemplary embodiments are described wherein the previous period usage memory comprises a last period accumulator and previous period usage lists.

Various exemplary embodiments are described further comprising when the current period expires: setting a period expiry time to define the end of a subsequent current period; and resetting the current period accumulator.

Various exemplary embodiments are described wherein the sliding window of previous periods is shorter than a billing period.

Various exemplary embodiments are described wherein the network node comprises a Policy and Charging Rules Function (PCRF) node.

Various exemplary embodiments are described including a network node adapted for tracking data usage in a sliding window of previous periods for a subscriber account, the network node comprising a processor and memory. The network node is configured to: during a current period, periodically receive usage data for a subscriber account and add the received usage data to a current period accumulator; when the current period expires: copy the value in the current period accumulator to previous period usage memory; calculate a total data usage for the sliding window of previous periods; and determine if the total data usage for the sliding window of previous periods exceeds a rolling window usage threshold and if so, set a window-usage-exceeded state for the subscriber account.

Various exemplary embodiments are described including a tangible and non-transitory machine-readable program storage device embodying a program of instructions executable by a processor in a network node to perform method steps for tracking data usage in a sliding window of previous periods for a subscriber account. The method steps comprise: during a current period, periodically receiving usage data for a subscriber account and adding the received usage data to a current period accumulator; when the current period expires: copying the value in the current period accumulator to previous period usage memory; calculating a total data usage for the sliding window of previous periods; and determining if the total data usage for the sliding window of previous periods exceeds a rolling window usage threshold and if so, setting a window-usage-exceeded state for the subscriber account.

### BRIEF DESCRIPTION OF THE FIGURES

Some embodiments of apparatus and/or methods in accordance with embodiments of the present invention are now described, by way of example only, and with reference to the accompanying drawings in which:

FIG. 1 illustrates a high-level block diagram of an exemplary network;

FIG. 2 illustrates a time chart for a sliding window arrangement according to an embodiment;

FIG. 3 illustrates a quota control policy process flow diagram according to an embodiment;

FIG. 4 illustrates a usage report monitor process flow diagram according to an embodiment;

FIG. 5 illustrates a new period creation process flow diagram according to an embodiment; and

FIG. 6 illustrates a high-level block diagram according to an embodiment.

In the figures, like features are denoted by like reference characters.

### DETAILED DESCRIPTION

Referring now to the drawings, in which like numerals refer to like components or steps, there are disclosed broad aspects of various exemplary embodiments. In use the invention is situated in a piece of network equipment which acts as a node in a network of network equipment. In operation the network elements communicate via connections which bind the individual network element to other network elements to form the overall network.

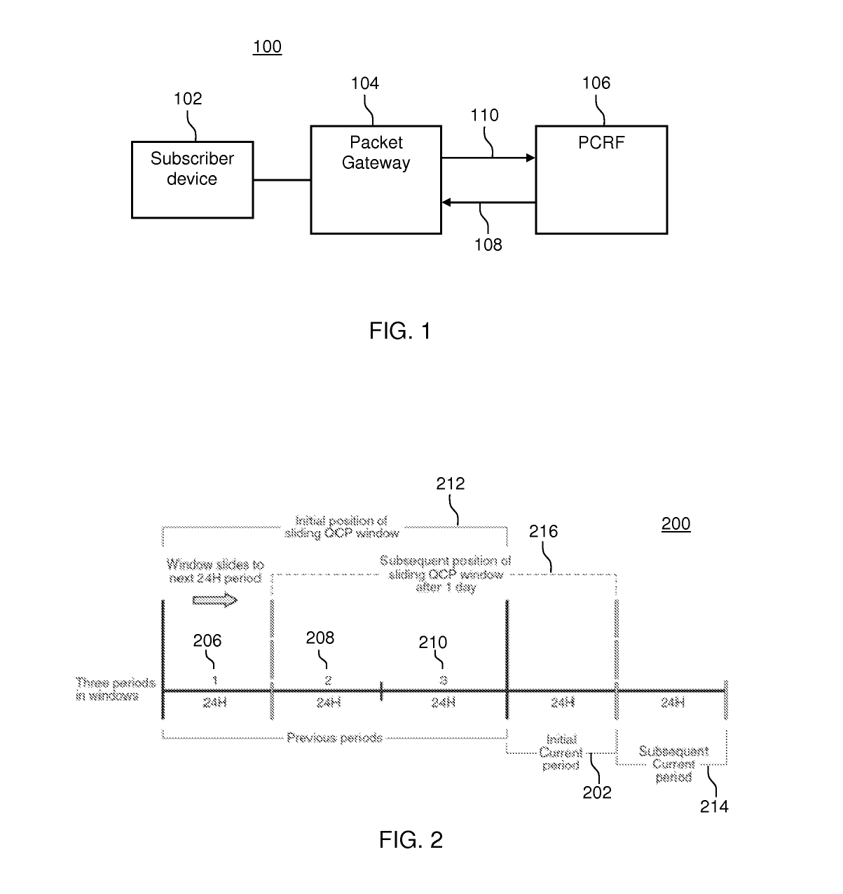

FIG. 1 illustrates a high-level block diagram of an exemplary network 100. One or more subscriber devices 102 associated with a subscriber account are in communication with a packet gateway 104. Packet gateway 104 communicates with a Policy and Charging Rules Function (PCRF) node 106. PCRF node 106 can send Quality of Service or other information to the gateway 104 via Credit Control Answer (CCA) or Re-Authorization Request (RAR) messages 108. The gateway 104 can send a Credit Control Request (CCR) message with usage report data for a session associated with a specific account/subscriber.

FIG. 2 illustrates a time chart 200 for a sliding window arrangement for a quota control policy according to an embodiment. For example, a service provider can define a billing period as one month. The billing period can be divided into smaller periods, for example, 24-hour periods 202, 206, 208, 210, 214. A sliding window can be defined as multiple periods, for example three periods. Sliding window 212 comprising three periods: 206, 208, 210. Sliding window 216 comprises periods 208, 210, 202. It is noted that other values for the duration of a billing period, a period and a sliding window could be defined as would be apparent to persons of skill in the art. A quota control policy can be applied to an initial current period 202 based on a subscriber's data usage during the corresponding initial sliding window 212. At the end of initial current period 202, the subsequent period 214 becomes the current period and a quota control policy will be determined based on the subscriber's data usage during the corresponding sliding window 216.

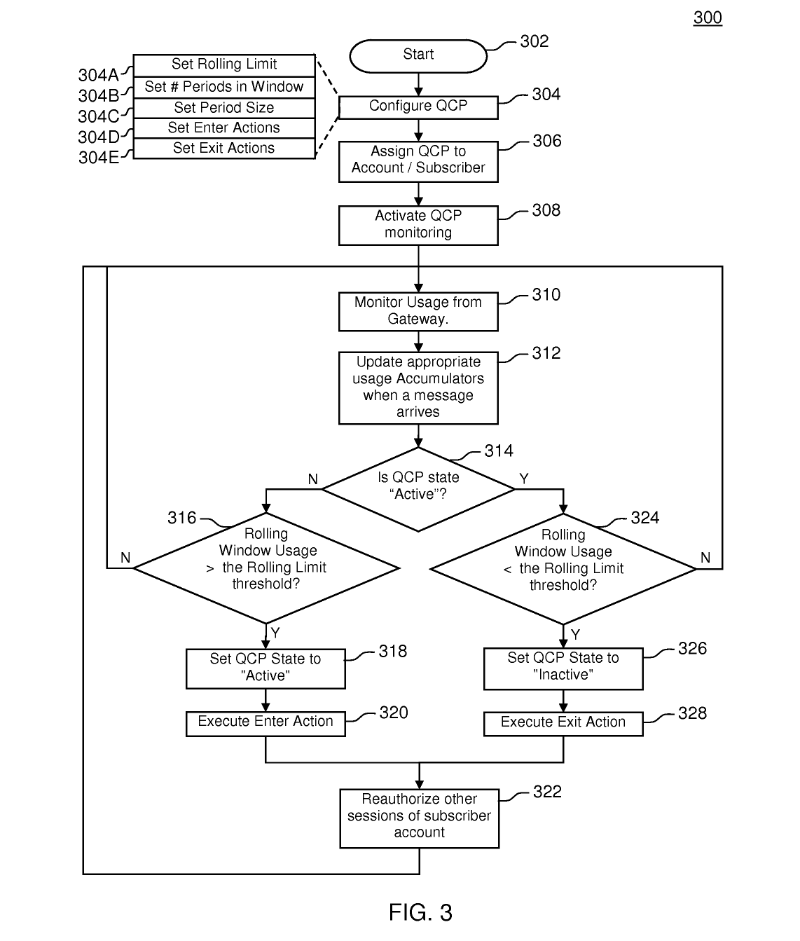

FIG. 3 illustrates a quota control policy process flow diagram according to an embodiment. The process can be executed on a network node such as for example, a Policy and Charging Rules Function (PCRF) node implementing 3GPP Policy Charging Control (PCC) architecture in a 3GPP-compliant packet data network. The process 300 starts at step 302. At step 304 the PCRF node configures a quota control policy (QCP) for a subscriber account. A subscriber account could apply to a single subscriber or a group of subscribers.

The configuration process can be initiated by an operator using a user interface in communication with the PCRF or the configuration could be implemented using an automated process. At step 304A the PCRF node sets a Rolling Limit which defines the threshold of data usage consumed by a subscriber account within the rolling window period. The Rolling Limit is smaller than the metering limit which is the data usage limit for a billing period for the subscriber account. At step 304B the PCRF node sets the number of measuring periods within the rolling window. At step 304C the PCRF node sets the measuring period size. For example, a subscriber billing period could be one month and a measuring period could be one day/24 hours, and the sliding window could comprise, for example, one or three or ten measuring periods.

At step 304D the PCRF node sets the Enter Actions, the action or actions to execute when the Rolling Limit is exceeded during a Rolling Window. Enter actions would be implemented in order to influence or control the data usage of the subscriber or subscribers, so as to reduce the likelihood that the metering limit will be exceeded during the billing period, while not unduly reducing service. Enter actions can include for example, one or more of the following: reduce Quality of Service (QoS); notify account/subscriber of the change; update account/subscriber data to add custom data or indicate the state of an account; etc.

At step 304E the PCRF node sets the Exit Actions, the action or actions to execute when the data usage for a subscriber account falls below Rolling Limit during a Rolling Window. At step 306 the PCRF node assigns the QCP to a subscriber account. A configured QCP can be assigned to multiple subscriber accounts. At step 308 the PCRF node activates QCP monitoring for a subscriber account.

At step 310 the PCRF node monitors usage reports from a gateway node. At step 312 the PCRF node stores the data from usage reports as they arrive and uses the data from usage reports to update appropriate usage accumulators for the subscriber account. Usage accumulators store the total data usage for a subscriber account for each measuring period. The PCRF node then calculates the subscriber account data usage for the rolling window 212 corresponding to the current period 202, by summing the totals of the usage accumulators for the periods 206, 208, 210 of the rolling window 212.

At step 314 the PCRF node determines if the QCP state is currently “Active” and if not then the process continues to step 316 where the PCRF node determines if rolling window usage exceeds the rolling limit threshold and if so then the process continues to step 318 where the PCRF node sets the QCP state to “Active” and at step 320 executes the Enter action or actions as defined at step 304D. Enter actions can be state actions or state-transit actions such that the notification/transit-custom data actions are executed on each state transition from “Inactive” to “Active”. The process continues to step 322 where the PCRF node reauthorizes other sessions associated with the subscriber account by, for example, sending a Re-Authorization Request (RAR) message to the packet gateway. Other sessions on the same subscriber account are reauthorized to apply the Enter or Exit actions to all the active sessions of all the subscribers associated with the account. The process returns to step 310. If at step 316, it is determined that the rolling limit threshold has not been exceeded, then the process returns to step 310.

If at step 314 the PCRF node determines that the QCP state is currently “Active” then the process continues to step 324 where the PCRF node determines if rolling window usage is below the rolling limit threshold and if so then the process continues to step 326 where the PCRF node sets the QCP state to “Inactive” and at step 328 executes the Exit action or actions as defined at step 304E. The Exit actions typically remove limitations imposed by the Enter actions or advise the subscriber or subscribers that the data usage rate has returned to a sustainable level. Exit actions are executed on each state transition from “Active” to “Inactive”. The process then continues to step 322 previously described.

In some embodiments, usage data is collected for a current period and a decision to change the QCP state is made based on total data usage during the corresponding sliding window of previous periods. In some embodiments, the process described above executes the Enter actions when the QCP state changes to “active” and as long as there is no change of state, the Enter actions are not performed again Likewise, the process described above executes the Exit actions when the QCP state changes to “inactive” and as long as there is no change of state, the Exit actions are not performed again.

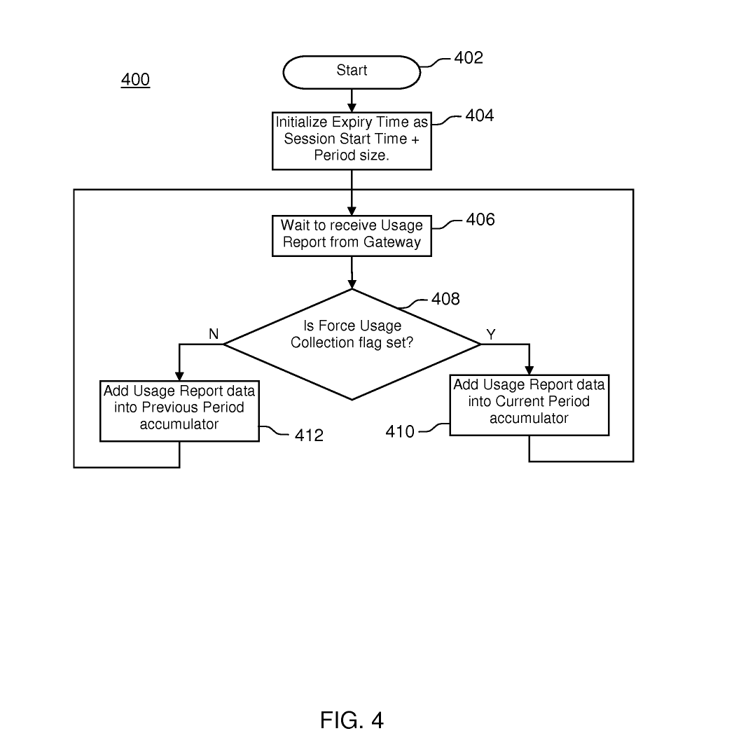

FIG. 4 illustrates a flow diagram for usage report monitor process according to an embodiment. The process can be executed on a network node such as for example, a PCRF node for a 3GPP-compliant packet data network. The process 400 starts at step 402. At step 404 the PCRF node initializes the expiry time as the session start time+period size. Thus the process will expire after the elapse of one period from the start of the communication session. At step 406 the PCRF node waits to receive usage reports from the gateway node. At step 408 the PCRF node determines if the “Force Usage Collection” flag is set and if so, the process proceeds to step 410 where the PCRF node adds the usage report data to the current period accumulator and the process then returns to step 406. If at step 408, the PCRF node determines that the “Force Usage Collection” flag is not set then the process proceeds to step 412 where the PCRF node adds the usage report data to the previous period accumulator. Without Force Usage Collection, when the PCRFnode receives a CCR message from the gateway with usage reported, it is not known how much of the data was used during the previous period thus it is just added to the current period accumulator. The process then returns to step 406.

Usage data reports received from the packet gateway contain the following information: account/subscriber identification; date/time of collection; total usage since last report.

QCP data is stored in the PCRF node in the following data accumulators: Current Period usage (usage currently being added to as usage reports arrive from the Gateways); Last Period usage (total usage from the period immediately before the current period); Previous Period usages (list of data copied from the Last Period).

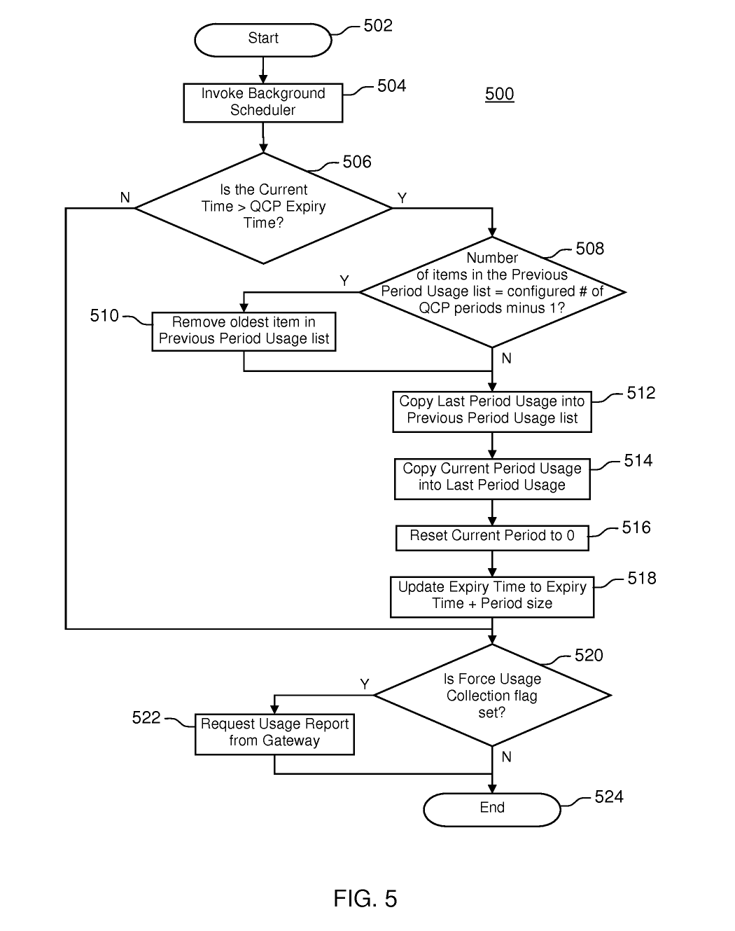

FIG. 5 illustrates a flow diagram for a new period creation process which is run periodically to check if the current period is expired and whether a new period needs to be generated. The process can be executed on a network node such as for example, a PCRF node for a 3GPP-compliant packet data network. The process 500 starts at step 502. At step 504 the PCRF node invokes a background scheduler periodically at a provisioned interval. At step 506 the PCRF node determines if the QCP period has expired by determining if the current time value exceeds the value of a time stamp set to mark the end of the current period. If the QCP period has expired, then a new period is created and a new sliding window established. The process proceeds to step 508 where the PRCF node determines if historical data needs to be shifted, by determining if the number of items in the previous period usage list equals the configured number of QCP periods minus one and if so then the process proceeds to step 510 where the PCRF node removes the oldest item in the previous period usage list. In this manner, the PCRF node maintains only usage data for the sliding window. The process then proceeds to step 512. If at step 508 the historical data does not need to be shifted then the process would proceed directly to step 512, where the PCRF node copies the Last Period Usage into Previous Period Usage list. At step 514 the PCRF node copies the Current Period Usage into Last Period Usage accumulator. At step 516 the PCRF node resets the Current Period usage accumulator to zero. At step 518 the PCRF node updates the Expiry Time to Expiry Time+Period size. The process then proceeds to step 520 where the PCRF node determines if the “Force Usage Collection” flag is set and if so, the process proceeds to step 522 where the PCRF node requests a usage report from the gateway, such as by sending a Re-Authorization Request (RAR) message to the packet gateway, requesting the packet gateway to report current session—level data usage for that session. The process then ends at step 524.

If at step 506 the PCRF node determines that the QCP period has not expired, then the process proceeds to step 520 as described above.

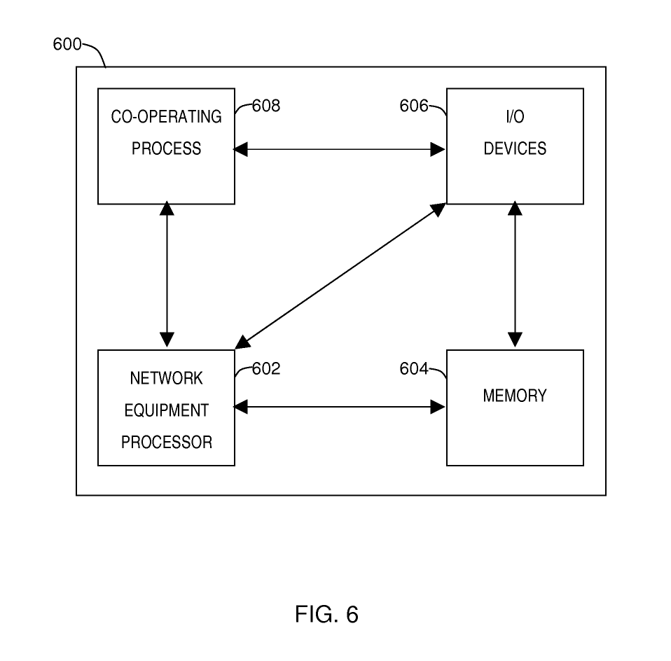

FIG. 6 depicts a high-level block diagram of a network equipment processor assembly suitable for use in performing functions described herein.

As depicted in FIG. 6, network equipment processor assembly 600 includes a network equipment processor element 602 (e.g., a central processing unit (CPU) and/or other suitable processor(s)), a memory 604 (e.g., random access memory (RAM), read only memory (ROM), and the like), a cooperating module/process 608, and various input/output devices 606 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in hardware, for example using one or more application specific integrated circuits (ASIC), and/or any other hardware equivalents. Alternatively, according to one embodiment, the cooperating process 608 can be loaded into memory 604 and executed by network equipment processor 602 to implement the functions as discussed herein. As well, cooperating process 608 (including associated data structures) can be stored on a tangible, non-transitory computer readable storage medium, for example magnetic or optical drive or diskette, semiconductor memory and the like.

It is contemplated that some of the steps discussed herein as methods may be implemented within hardware, for example, as circuitry that cooperates with the network equipment processor to perform various method steps. Portions of the functions/elements described herein may be implemented as a computer program product wherein computer instructions, when processed by a network equipment processor, adapt the operation of the network equipment processor such that the methods and/or techniques described herein are invoked or otherwise provided. Instructions for invoking the inventive methods may be stored in fixed or removable media, and/or stored within a memory within a computing device operating according to the instructions.

The functions of the various elements shown in the Figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the Figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

It should also be understood that the steps of the exemplary methods set forth herein are not necessarily required to be performed in the order described, and the order of the steps of such methods should be understood to be merely exemplary Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

It should be appreciated by those skilled in the art that any block diagrams herein represent conceptual views of illustrative circuitry embodying the principles of the invention. Numerous modifications, variations and adaptations may be made to the embodiment of the invention described above without departing from the scope of the invention, which is defined in the claims.

What is claimed is:

1. A method for tracking data usage in a sliding window of previous periods for a subscriber account, the method performed by a processor on a network node, the method comprising the steps of:
during a current period, periodically receiving usage data for a subscriber account and adding the received usage data to a current period accumulator;
when the current period expires:
copying the value in the current period accumulator to previous period usage memory;
calculating a total data usage for the sliding window of previous periods; and
determining if the total data usage for the sliding window of previous periods exceeds a rolling window usage threshold and if so, setting a window-usage-exceeded state for the subscriber account.

2. The method of claim 1, wherein the calculating a total data usage comprises adding data usage values corresponding to each of the previous periods within the sliding window of previous periods.

3. The method of claim 1, wherein the previous period usage memory comprises a last period accumulator and previous period usage lists.

4. The method of claim 1, further comprising when the current period expires:
setting a period expiry time to define the end of a subsequent current period; and
resetting the current period accumulator.

5. The method of claim 1, wherein the sliding window of previous periods is shorter than a billing period.

6. The method of claim 1, wherein the network node comprises a Policy and Charging Rules Function (PCRF) node.

7. A network node adapted for tracking data usage in a sliding window of previous periods for a subscriber account, the network node comprising a processor and memory, the network node configured to:
during a current period, periodically receive usage data for a subscriber account and add the received usage data to a current period accumulator;
when the current period expires:
copy the value in the current period accumulator to previous period usage memory;
calculate a total data usage for the sliding window of previous periods; and
determine if the total data usage for the sliding window of previous periods exceeds a rolling window usage threshold and if so, set a window-usage-exceeded state for the subscriber account.

8. The network node of claim 7, wherein the calculate a total data usage comprises add data usage values corresponding to each of the previous periods within the sliding window of previous periods.

9. The network node of claim 7, wherein the previous period usage memory comprises a last period accumulator and previous period usage lists.

10. The network node of claim 7, further configured to, when the current period expires:
set a period expiry time to define the end of a subsequent current period; and
reset the current period accumulator.

11. The network node of claim 7, wherein the sliding window of previous periods is shorter than a billing period.

12. The network node of claim 7, wherein the network node comprises a Policy and Charging Rules Function (PCRF) node.

13. A tangible and non-transitory machine-readable program storage device embodying a program of instructions executable by a processor in a network node to perform method steps for tracking data usage in a sliding window of previous periods for a subscriber account, the method steps comprising:
during a current period, periodically receiving usage data for a subscriber account and adding the received usage data to a current period accumulator;
when the current period expires:
copying the value in the current period accumulator to previous period usage memory;
calculating a total data usage for the sliding window of previous periods; and
determining if the total data usage for the sliding window of previous periods exceeds a rolling window usage threshold and if so, setting a window-usage-exceeded state for the subscriber account.

14. The tangible and non-transitory machine-readable program storage device of claim 13, wherein the calculating a total data usage comprises adding data usage values corresponding to each of the previous periods within the sliding window of previous periods.

15. The tangible and non-transitory machine-readable program storage device of claim 13, wherein the previous period usage memory comprises a last period accumulator and previous period usage lists.

16. The tangible and non-transitory machine-readable program storage device of claim 13, wherein the method steps further comprise, when the current period expires:
setting a period expiry time to define the end of a subsequent current period; and
resetting the current period accumulator.

17. The tangible and non-transitory machine-readable program storage device of claim 13, wherein the sliding window of previous periods is shorter than a billing period.

18. The tangible and non-transitory machine-readable program storage device of claim 13, wherein the network node comprises a Policy and Charging Rules Function (PCRF) node.
